(19) United States
(12) Patent Application Publication
(10) Pub. No.: US 2022/0212286 A1
(43) Pub. Date: Jul. 7, 2022

(54) WELDING METHOD AND WELDING EQUIPMENT

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Yasutaka KAWADA, Kawasaki (JP); Yoshinobu MAKINO, Machida (JP); Kouhei YAMADA, Komae (JP); Takehisa HINO, Chigasaki (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 17/646,350

(22) Filed: Dec. 29, 2021

(30) Foreign Application Priority Data
Jan. 4, 2021 (JP) 2021-000205

(51) Int. Cl. B23K 26/342; B23K 26/14

(52) U.S. Cl. CPC B23K 26/342; B23K 26/1462

(57) ABSTRACT

A welding method, which subjects a surface to be built-up of an elongated workpiece to a build-up welding process along a longitudinal direction of the workpiece, includes a step for forming a build-up layer on the surface to be built-up by supplying a filler metal to the surface to be built-up along the longitudinal direction and by applying a laser beam thereto to melt the filler metal. A refrigerant is supplied to the surface to be built-up of the workpiece, during the step for forming the build-up layer.

### CROSS-REFERENCE TO RELATED APPLICATIONS

This application is based upon and claims the benefit of priority from Japanese Patent Application No. 2021-000205, filed Jan. 4, 2021; the entire contents of which are incorporated herein by reference.

### FIELD

An embodiment described herein relates to a welding method and a welding equipment.

### BACKGROUND

Reduction of the emission of greenhouse gases, which is typified by carbon dioxide, is required for environmental protection. In order to reduce carbon dioxide emissions, a thermal power plant, which uses a large amount of fossil fuel is desired to improve power generation efficiency.

In order to improve the power generation efficiency of a thermal power plant, it is effective to increase a temperature of steam flowing through the thermal power plant. Thus, components used in a thermal power plant need to have superior high-temperature resistance and improved wear resistance more than ever before.

For example, a steam valve which controls the flow rate of steam flowing into a steam turbine opens and closes while being exposed to a high temperature and high pressure steam. A valve stem which is a part of the steam valve is required to be escaped from wear caused by sliding and from generation of an oxidized scale. This is due to the following reasons. Namely, when the valve stem is worn by sliding, an amount of steam leaking from a gap between the valve stem and a valve chest increases, which lowers the thermal efficiency of the thermal power plant. In addition, the valve stem reacts with high temperature steam to form an oxidized scale on its surface. The formation of the oxidized scale increases an external diameter of the valve stem. Then, the oxidized scale peels off and accumulates around the valve stem. When the external diameter of the valve stem increases and/or when the oxidized scale accumulates between the valve stem and the valve chest, the valve stem cannot move as desired.

In terms of this point, JPH6-174126 discloses a method of forming a build-up layer by welding a cobalt-base alloy to a surface of a valve stem base material to form a hardened layer (build-up layer) in order to improve wear resistance of the valve stem and to prevent generation of an oxidized scale.

However, it was found that a portion of the valve stem manufactured by the method described in JPH6-174126 did not have sufficient wear resistance to withstand use in a thermal power plant where high temperature steam flows. More specifically, it was found that the hardness of the build-up layer formed on the valve stem was sufficient in the vicinity of a weld start portion, but was insufficient from the vicinity of a weld middle portion to the vicinity of a weld end portion.

### BRIEF DESCRIPTION OF THE DRAWINGS

FIG. 1 is a side view showing a wear-resistant member according to an embodiment of the present invention, wherein a build-up layer is formed on a workpiece.

FIG. 2 is a side view showing a welding equipment for forming the build-up layer shown in FIG. 1.

FIG. 3 is a view showing a cross-section of the welding equipment shown in FIG. 2 along the III-III line in the figure.

FIG. 4 is a partially enlarged view showing the welding torch and the nozzle shown in FIG. 2.

FIG. 5 is a view corresponding to FIG. 4, showing a modification example of the welding equipment.

### DETAILED DESCRIPTION

In an embodiment, a welding method for subjecting a surface to be built-up of an elongated workpiece to a build-up welding process along a longitudinal direction of the workpiece comprises:

a step for forming a build-up layer on the surface of the workpiece by supplying a filler metal to the surface of the workpiece along the longitudinal direction and by applying a laser beam thereto to melt the filler metal;

wherein a refrigerant is supplied to the surface to be built-up of the workpiece, during the step for forming the build-up layer.

In an embodiment, a welding equipment for subjecting a surface to be built-up of an elongated workpiece to a build-up welding process along a longitudinal direction of the workpiece comprises:

a supporter that supports the workpiece;

a filler-metal supply unit that supplies a filler metal to the surface to be built-up of the workpiece;

a laser irradiator having a laser oscillator and a laser emitter that emits a laser beam oscillated by the laser oscillator toward the workpiece supported by the supporter;

a longitudinal motion drive that relatively moves the laser emitter along the longitudinal direction with respect to the workpiece supported by the supporter; and

a refrigerant supply unit that supplies a refrigerant to the surface to be built-up of the workpiece supported by the supporter.

Alternatively, in an embodiment, a welding equipment for subjecting a surface to be built-up of an elongated workpiece to a build-up welding process along a longitudinal direction of the workpiece comprises:

a filler-metal-layer forming unit that forms a filler metal layer by thermally spraying or applying a filler metal to the surface of the workpiece;

a supporter that supports the workpiece with the filler metal layer formed thereon;

a laser irradiator having a laser oscillator and a laser emitter that emits a laser beam oscillated by the laser oscillator toward the workpiece supported by the supporter;

a longitudinal motion drive that relatively moves the laser emitter along the longitudinal direction with respect to the workpiece supported by the supporter; and

a refrigerant supply unit that supplies a refrigerant to the surface to be built-up of the workpiece supported by the supporter.

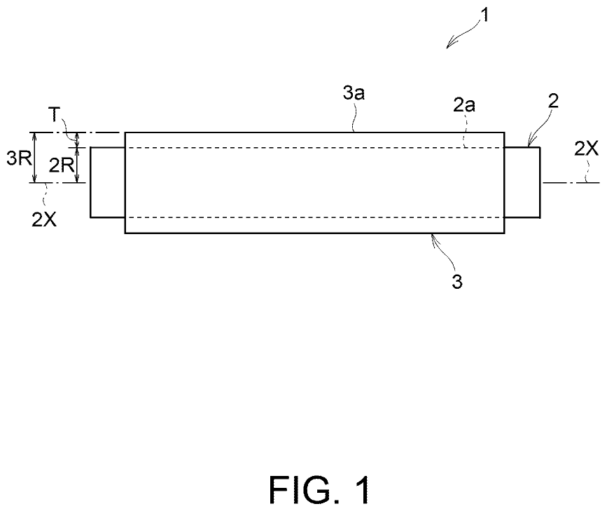

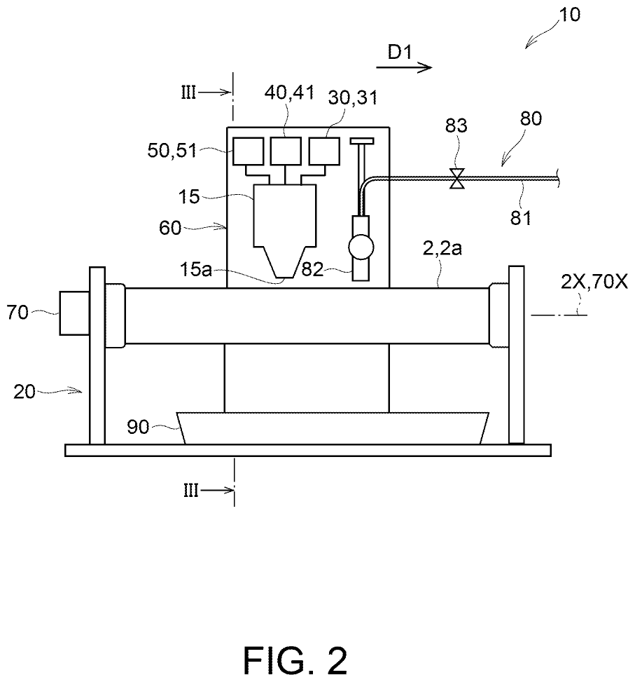

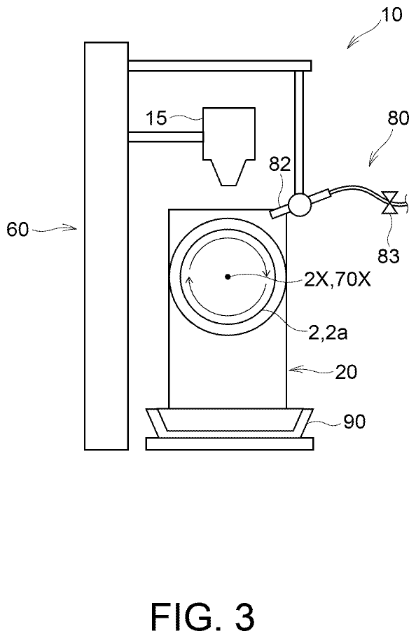

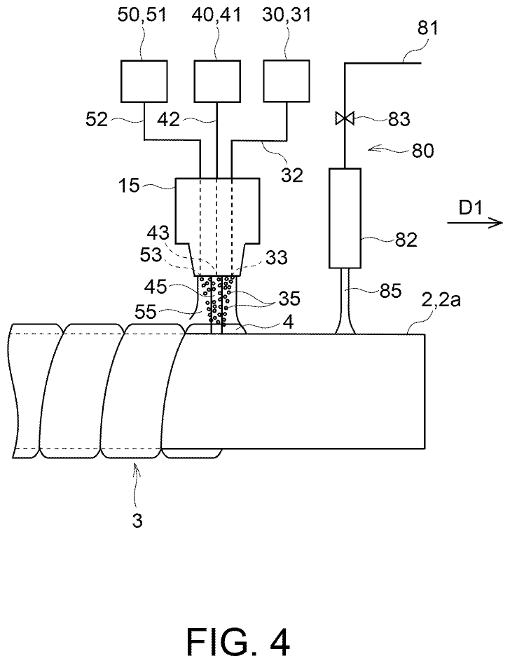

An embodiment is described with reference to the drawings. FIG. 1 is a view showing a wear-resistant member according to an embodiment. FIGS. 2 and 3 are views schematically showing a structure of a welding equipment for manufacturing the wear-resistant member shown in FIG. 1. FIG. 3 is a view showing a cross-section of the welding equipment shown in FIG. 2 along the III-III line in the figure. In FIG. 3, illustration of a filler-metal supply unit 30, a laser irradiator 40 and a shielding gas supply unit 50 described below is partially omitted for the sake of simplicity of illustration. FIG. 4 is a view partially showing the welding equipment shown in FIGS. 2 and 3 in enlargement.

A wear-resistant member 1 shown in FIG. 1 is manufactured by a build-up welding process for forming a build-up layer 3 on a surface to be built-up 2a of a workpiece 2. A welding equipment 10 shown in FIGS. 2 and 3 subjects the surface to be built-up 2a of the workpiece 2 to the build-up welding process. More specifically, the welding equipment 10 forms the build-up layer 3 on the surface to be built-up 2a of the workpiece 2 with a filler metal 35 that is molten by means of a laser beam 45.

As shown in FIG. 1, the workpiece 2 has an elongated shape with a longitudinal direction. In the illustrated example, the workpiece 2 is formed in a solid cylindrical shape, and has a cylindrical surface (surface to be built-up 2a). In the illustrated example, the workpiece 2 is a forged bar of nickel (Ni)-base alloy. It goes without saying that the shape of the workpiece 2 and the material forming the workpiece 2 are not limited thereto. For example, the workpiece 2 may be formed in a hollow cylindrical shape. In addition, the material forming the workpiece 2 may be an iron (Fe)-base alloy. In this specification, the nickel-base alloy refers to a material having the highest fractions by weight of nickel elements, and the iron-base alloy refers to a material having the highest fractions by weight of iron elements.

As shown in FIG. 2, the welding equipment 10 has a supporter 20 that supports the workpiece 2, a filler-metal supply unit 30 that supplies the filler metal 35 to the workpiece 2, a laser irradiator 40 that applies the laser beam 45 to the workpiece 2, a shielding gas supply unit 50, a longitudinal motion drive 60 that relatively moves the laser irradiator 40 with respect to the supporter 20, and a rotational motion unit 70 that rotates the workpiece 2 supported by the supporter 20.

The supporter 20 supports both the ends of the elongated workpiece 2. The supporter 20 supports both the longitudinal ends of the workpiece 2 such that the workpiece 2 is rotatable around a rotation axis 70X along the longitudinal direction.

As shown in FIG. 4, the filler-metal supply unit 30 has a filler-metal housing 31 that houses powder of the filler metal 35, a filler-metal supply tube 32 that leads the powder of the filler metal 35 derived from the filler-metal housing 31 to the vicinity of the workpiece 2 supported by the supporter 20, and a filler-metal ejection hole 33 provided at the distal end of the filler-metal supply tube 32 to eject the filler metal 35. The filler metal 35 may be a cobalt (Co)-base alloy, a nickel-base alloy and an iron-base alloy, for example. The filler-metal supply unit 30 may further have a carrier-gas supply unit (not shown) that supplies a carrier gas to the filler-metal supply tube 32. In this case, when the filler metal 35 is ejected from the filler-metal ejection hole 33, the filler metal 35 accompanied by a carrier gas can be supplied to the workpiece 2.

As shown in FIG. 4, the laser irradiator 40 applies the laser beam 45 to the workpiece 2 supported by the supporter 20. The laser irradiator 40 has a laser oscillator 41, an optical fiber 42 that guides the laser beam 45 oscillated by the laser oscillator 41 to the vicinity of the workpiece 2 supported by the supporter 20, and a laser emitter 43 provided at the distal end of the optical fiber 42 to emit the laser beam 45 guided by the optical fiber 42 toward the workpiece 2 supported by the supporter 20. The laser oscillator 41 may be an oscillator using any laser such as a semiconductor laser or a solid-state laser, for example. The laser oscillator 41 is preferably capable of oscillating the laser beam 45 in a wavelength range of from 800 to 1100 nm.

As shown in FIG. 4, the shielding gas supply unit 50 has a shielding gas housing 51 that houses a shielding gas 55, a gas supply tube 52 that leads the shielding gas 55 derived from the shielding gas housing 51 to the vicinity of the workpiece 2 supported by the supporter 20, and a shielding gas ejection hole 53 provided at the distal end of the gas supply tube 52 to eject the shielding gas 55. The shielding gas 55 may be an inert gas such as helium, argon or nitrogen, for example.

In the illustrated example, the welding equipment 10 has a welding torch 15. The welding torch 15 has a distal end surface 15a where the aforementioned filler-metal ejection hole 33, the laser emitter 43 and the shielding gas ejection hole 33 are formed. The welding torch 15 is positioned such that its distal end surface 15a faces the surface to be built-up 2a of the workpiece 2 supported by the supporter 20. The welding torch 15 is provided to be relatively movable in the aforementioned longitudinal direction with respect to the supporter 20.

The longitudinal motion drive 60 shown in FIGS. 2 and 3 relatively moves the laser emitter 43 along the longitudinal direction with respect to the workpiece 2 supported by the supporter 20. In the illustrated example, the longitudinal motion drive 60 moves the welding torch 15 in the longitudinal direction with respect to the supporter 20. The longitudinal motion drive 60 moves the welding torch 15 in the direction D1 from one end of the workpiece 2 supported by the supporter 20 toward the other end thereof. It goes without saying that the longitudinal motion drive 60 may move the supporter 20 in the longitudinal direction with respect to the welding torch 15.

The rotational motion unit 70 rotates the workpiece 2 supported by the supporter 20 around the rotation axis 70X. In the illustrated example, the rotation axis 70X corresponds to the axis 2X of the workpiece 2 (the central axis of the cylindrical surface to be built-up 2a). The rotational motion unit 70 rotates the workpiece 2 at a predetermined rotating speed. In the example shown in FIG. 3, the rotational motion unit 70 rotates the workpiece 2 clockwise in FIG. 3, but the present invention is not limited thereto. The rotational motion unit 70 may rotate the workpiece 2 counterclockwise in FIG. 3.

Since the welding torch 15 is relatively moved by the longitudinal motion drive 60 in the longitudinal direction with respect to the workpiece 2, and the workpiece 2 is rotated by the rotational motion unit 70 around the rotation axis 70X, the welding torch 15 draws a spiral trajectory around the surface to be built-up 2a of the workpiece 2.

In recent years, in order to improve the power generation efficiency of a thermal power plant, it has been desired to improve a wear resistance of a component used in the thermal power plant and to suppress formation of an oxidized scale on the component. For example, when the wear-resistant member shown in FIG. 1 is used as a valve stem of a steam valve, an opening and closing action of the steam valve with the movement of the valve stem can be more reliable by improving the wear resistance of the build-up layer. Namely, when the build-up layer is worn as the valve stem slides, the amount of steam leaking from a gap between the valve stem and the valve chest increases, which lowers the thermal efficiency of the thermal power plant. In addition, an oxidized scale formed on the valve stem increases an external diameter of the valve stem. Alternatively, the oxidized scale peels off and accumulates around the valve stem. When the external diameter of the valve stem increases and/or when the oxidized scale accumulates between the valve stem and the valve chest, the valve stem cannot move as desired. In terms of this point, JPH6-174126 discloses a method of forming a build-up layer by welding a cobalt-base alloy to a surface to be built-up of a workpiece in order to improve wear resistance of a valve stem and to suppress an generation of oxidized scale.

However, the inventors found that, when a wear-resistant member is manufactured by the method described in JPH6-174126, the hardness of the build-up layer differs along the longitudinal direction of the workpiece. Specifically, when the portion of the build-up layer at which the welding is started is referred to as weld start portion, the portion thereof at which the welding is ended is referred to as weld end portion, and the middle portion thereof between the weld start portion and the weld end portion is referred to as weld middle portion, the hardness of the build-up layer from the vicinity of the weld middle portion to the vicinity of the weld end portion was found to be lower than the hardness of the build-up layer in the vicinity of the weld start portion. After having conducted extensive studies, the inventors discovered the cause of the decrease in hardness of the build-up layer from the vicinity of the weld middle portion to the vicinity of the weld end portion. Namely, from the start to the end of the build-up welding process, heat is applied to the workpiece by a laser beam. Thus, the temperature of each portion of the workpiece increases along a welding direction (the direction in which the welding torch travels). As a result, the dilution rate of components of the filler metal in each portion of the build-up layer increases along the welding direction (in other words, from the weld start portion toward the weld end portion). When the dilution rate becomes excessively high, the hardness of the build-up layer becomes insufficient for use in a thermal power plant where high temperature steam flows.

In consideration of this point, the welding equipment 10 and the welding method in the embodiment are devised to prevent the increase in dilution rate of components of the filler metal 35 in the build-up layer 3 from the weld middle portion to the weld end portion, so as to increase the hardness of the build-up layer 3. Specifically, during the period from the start to the end of welding, the build-up welding process is performed in such a manner that the workpiece 2 is cooled to decrease the temperature of the surface to be built-up 2a. This can prevent the increase in temperature of the workpiece 2 during the build-up welding process, whereby the dilution rate of the build-up layer 3 is prevented from becoming excessively high. As a method of preventing the increase in temperature of the workpiece 2 during the build-up welding process, it may be considered that the laser beam application to the workpiece 2 is interrupted during the build-up welding process (i.e., the build-up welding process is interrupted) to dissipate the heat of the workpiece 2, or that an output or the like of the laser beam 45 from the laser oscillator 41 is controlled as appropriate during the build-up welding process. However, when the build-up welding process is interrupted, it takes longer to complete the build-up welding process from the start to the end. Thus, the build-up welding cannot be efficiently performed. In addition, it is difficult to regulate welding conditions during the build-up welding process as appropriate in such a manner that the dilution rate is kept lower than a predetermined value. On the other hand, the method in which the build-up welding process is performed while the workpiece 2 is cooled makes it possible to prevent the increase in temperature of the workpiece 2 and to prevent the resulting increase in dilution rate, while performing the build-up welding process under predetermined welding conditions without interrupting the build-up welding process.

In order to cool the workpiece 2 during the build-up welding process as described above, the welding equipment 10 further comprises a refrigerant supply unit 80. The refrigerant supply unit 80 has a refrigerant conduit 81 that leads a refrigerant 85 from a refrigerant supply source (not-shown) to the vicinity of the workpiece 2 supported by the supporter 20, a nozzle 82 provided at the distal end of the refrigerant conduit 81 to eject the refrigerant 85, and a flow-rate regulation valve 83 that regulates a flow rate of the refrigerant 85 ejected from the nozzle 82. Since the workpiece 2 is cooled by the refrigerant 85, the increase in temperature of the workpiece 2 due to the application of the laser beam 45 from the laser emitter 40 is suppressed.

In the illustrated example, the refrigerant 85 is water. The use of water as the refrigerant 85 prevents the possibility that the workpiece 2, the build-up layer 3 and the welding equipment 10 are adversely affected by the refrigerant. The refrigerant may be tap water. In this case, the refrigerant conduit 81 may be connected to a water supply. The temperature of the refrigerant 85 is preferably 30° C. or less, more preferably 25° C. or less, and further preferably 20° C. or less. This can prevent the possibility that the workpiece 2 is not sufficiently cooled so that a dilution rate of components of the filler metal 35 becomes higher than a desired dilution rate in the build-up step described below. Hence, the possibility that the hardness of the build-up layer 3 becomes lower than a desired hardness can be prevented. The temperature of the refrigerant 85 is preferably 0° C. or more, more preferably 5° C. or more, and further preferably 10° C. or more. This can prevent the possibility that the temperature of the workpiece 2 becomes so low that the build-up layer 3 and the workpiece 2 fuse insufficiently. The temperature of tap water supplied from a water supply is generally between 5° C. and 25° C. Thus, the use of tap water as the refrigerant 85 eliminates the need for regulating the temperature of the refrigerant 85.

The nozzle 82 has a tubular shape and the refrigerant 85 from it trickles down in a continuous current (in a small stream). Since the refrigerant 85 from the nozzle 82 trickles down in a continuous current (in a small stream) (in other words, since the refrigerant 85 is not sprayed from the nozzle 82), the refrigerant 85 is prevented from being scattered and landing on the welding equipment 10.

When the refrigerant 85 is sprayed from the nozzle 82 or the flow rate of the refrigerant 85 ejected from the nozzle 82 is high so that the refrigerant 85 is scattered, it is preferable to arrange a shielding plate or cover as appropriate in order to reduce the possibility that the refrigerant 85 lands on the welding equipment 10. The refrigerant 85 may be a liquid other than water, and it may be even a gas. When the refrigerant 85 is a gas, in order to prevent the gas from diffusing around, it is preferable to arrange a shielding plate or cover as appropriate.

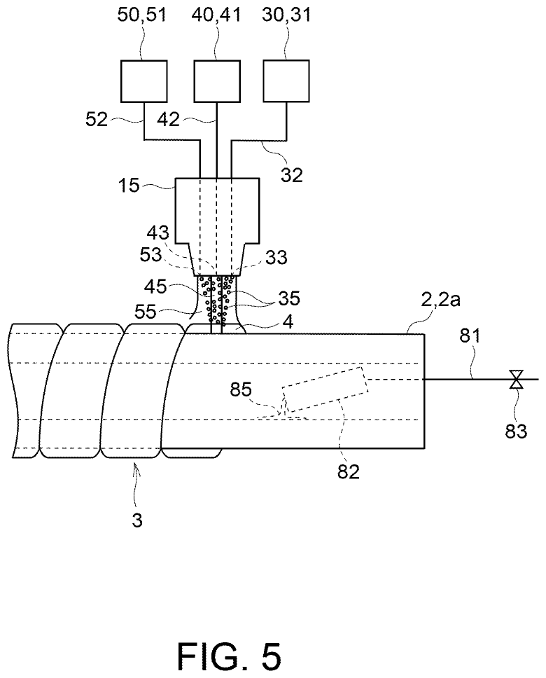

In the illustrated example, as shown in FIG. 3, the distal end of the nozzle 82 is positioned above the workpiece 2 to face the surface to be built-up 2a, and supplies the refrigerant 85 to the surface to be built-up 2a. On the other hand, when the workpiece 2 is hollow, as shown in FIG. 5, the nozzle 82 may be positioned in the hollow area inside the workpiece 2, and may supply the refrigerant 85 to the hollow area. In this case, the possibility that the refrigerant 85 scatters or diffuses is prevented by the workpiece 2 itself.

The nozzle 82 is provided to be relatively movable along the longitudinal direction with respect to the workpiece 2 supported by the supporter 20. In the illustrated example, the nozzle 82 is moved, together with the welding torch 15 (laser emitter 43), by the longitudinal motion drive 60, in the longitudinal direction with respect to the supporter 20. Thus, the increase in temperature of the workpiece 2 caused by the heat applied by the laser beam 45 can be efficiently prevented during the below-described build-up step from the start to the end.

Further, in the illustrated example, as shown in FIGS. 2 and 4, the nozzle 82 is arranged forward the welding torch 15 (laser emitter 43) in the relative movement direction D1 of the welding torch 15 (laser emitter 43) with respect to the workpiece 2. Thus, the refrigerant 85 is supplied, in the aforementioned relative movement direction D1, at a position forward a position of the workpiece 2 to which the laser beam 45 is applied. Thus, each portion of the workpiece 2 can be cooled before the filler metal 35 molten by the laser beam 45 lands on the portion. In this case, as compared with a case in which a portion of the workpiece 2 is cooled immediately after the molten filler metal 35 lands on the portion, the possibility of cracking of the build-up layer 3 is reduced.

As shown in FIGS. 2 and 3, the welding equipment 10 may have a bucket 90 for receiving the refrigerant 85 having been supplied to the workpiece 2. The bucket 90 is arranged below the workpiece 2 supported by the supporter 20.

Next, an operation of the embodiment as structured above will be described. Herein, a welding method using the aforementioned welding equipment 10 is described.

First, as shown in FIG. 2, the both ends of the workpiece 2 are supported by the supporter 20.

Following thereto, the welding torch 15 and the nozzle 82 are positioned in the vicinity of the aforementioned one end of the workpiece 2. In the illustrated example, the nozzle 82 is positioned forward the welding torch 15 in the movement direction D1 of them moved by the longitudinal motion drive 60.

Then, the workpiece 2 is rotated by the rotational motion unit 70 around the rotation axis 70X. In addition, the movement of the welding torch 15 and the nozzle 82 along the longitudinal direction is started by the longitudinal motion drive 60. The welding torch 15 and the nozzle 82 are moved in the aforementioned movement direction D1.

Next, the build-up step for forming the build-up layer 3 on the workpiece 2 is performed. In this build-up step, the refrigerant 85 is supplied from the nozzle 82 to the workpiece 2 first. Then, the filler metal 35 is supplied from the welding torch 15 to the surface to be built-up 2a of the workpiece 2, and the laser beam 45 is applied thereto. The build-up step of forming the build-up layer is performed in such a manner that the workpiece 2 is being rotated by the rotational motion unit 70 while the welding torch 15 and the nozzle 82 are being moved by the longitudinal motion drive 60.

In the illustrated example, the refrigerant 85 is supplied to a position forward the welding torch 15 in the movement direction D1 of the welding torch 15 moved by the longitudinal motion drive 60. Thus, each portion of the workpiece 2 is cooled before the filler metal 35 molten by the laser beam 45 lands on the portion.

In the illustrated example, the laser beam 45 is emitted from the laser emitter 43 of the welding torch 15. For this while, the powdery filler metal 35 is supplied from the filler-metal ejection hole 33 of the welding torch 15. The filler metal 35 is supplied from around the laser beam 45 along the laser beam 45. Thus, the powdery filler metal 35 is molten by the laser beam 45. In addition, the workpiece 2 is partially molten by the laser beam 45. The molten filler metal 35 and the molten portion of the workpiece 2 form a molten pool 4 on the surface to be built-up 2a of the workpiece 2. Then, components of the molten filler metal 35 are dissolved in the molten portion of the workpiece 2, and components of the molten portion of the workpiece 2 are dissolved in the molten filler metal 35. The powdery filler metal 35 ejected from the filler-metal ejection hole 33, and the molten pool 4 formed by the molten filler metal 35 and the molten portion of the workpiece 2 are surrounded by the shielding gas 55 supplied from the shielding gas ejection hole 53 and thus are prevented from being oxidized by the atmosphere.

During the build-up step, the welding torch 15 is moved with respect to the workpiece 2, so that the molten pool 4 formed on the surface to be built-up 2a of the workpiece 2 becomes away from the laser beam 45 and solidifies to become the build-up layer 3. In addition, during the build-up step, the welding torch 15 draws a spiral trajectory around the surface to be built-up 2a of the workpiece 2, so that the molten pool 4 and the build-up layer 3 are formed on the surface to be built-up 2a along the above spiral trajectory.

Since the refrigerant 85 is supplied to the workpiece 2 during the build-up step, the increase in temperature of the workpiece 2 caused by the heat applied by the laser beam 45 is suppressed. Thus, it is not necessary to interrupt the build-up step to dissipate the heat of the workpiece 2. It is also not necessary to regulate a welding condition, such as an output of the laser beam 45 from the laser oscillator 41, during the build-up step as appropriate in order to prevent the increase in temperature of the workpiece 2. Further, since the supply of the refrigerant 85 is performed along the movement direction D1 of the position on which the laser beam 45 hits the workpiece 2, the increase in temperature of the workpiece 2 caused by the heat applied by the laser beam 45 can be efficiently prevented from the start to the end of the build-up step. Moreover, since the refrigerant 85 is supplied at a position forward the position on which the laser beam 45 hits the workpiece 2 in the movement direction D1, each portion of the workpiece 2 is cooled before the filler metal 35 molten by the laser beam 45 lands on the portion. Thus, as compared with a case in which a portion of the workpiece 2 is cooled immediately after the molten filler metal 35 lands on the portion, the possibility of cracking of the build-up layer 3 is reduced.

After the build-up step, a surface treatment step for machining the surface of the build-up layer 3 to smooth the surface (into a cylindrical surface) may be performed.

Next, the present invention will be described more specifically by means of an example, but the present invention is not limited to the following example, as long as they are within the scope of the invention.

### Example

The workpiece 2 was subjected to build-up welding using the aforementioned welding equipment 10, whereby one build-up layer 3 was formed on the surface to be built-up 2a of the workpiece 2, as shown in FIG. 1. A cylindrical forged bar of nickel-base alloy was used as the workpiece 2, and powder of cobalt-base alloy was used as the filler metal 35. An oscillator using a semiconductor laser was used as the laser oscillator 41, and tap water was used as the refrigerant 85. Then, the build-up step was performed under the following welding conditions. The welding conditions were unchanged from the start to the end of the welding.

<Welding Conditions>

Laser output: 2 kW to 10 kW

Feed rate of filler metal: 10 g/min to 60 g/min

Welding speed: 200 mm/min to 1000 mm/min

Average flow rate of refrigerant: 180 g/min

The term “welding speed” means here the speed of the welding torch 15 with respect to the surface to be built-up 2a of the workpiece 2 (the speed of the welding torch 15 along the spiral trajectory described above).

The surface treatment step was performed by machining the build-up layer 3 formed on the workpiece 2 under the aforementioned conditions so that the build-up layer 3 had a thickness of 0.5 mm. The thickness of the build-up layer 3 was measured here with reference to the original position of the surface to be built-up 2a of the workpiece 2 before performing build-up welding. In other words, the thickness of the build-up layer 2 is a difference T between a radius 3R of the outer peripheral surface 3a of the build-up layer 3 formed on the workpiece 2 and the radius 2R of the outer peripheral surface (surface to be built-up 2a) of the workpiece 2 before the workpiece 2 is subjected to build-up welding.

After the surface treatment step had been performed, a sectional sample of the obtained wear-resistant member 1 was made, and the hardness of the build-up layer 3 and the dilution rate of the filler metal 35 in the build-up layer 3 were measured. The hardness is measured by using the Vickers hardness test.

### Comparative Example

The build-up step and the surface treatment step were performed in the same way as in Example, except that cooling of the workpiece 2 by the refrigerant 85 was not performed during build-up welding. Then, the hardness of the build-up layer 3 and the dilution rate of components of the filler metal 35 in the build-up layer 3 were measured in the same way as in Example.

(Evaluation)

Table 1 shows the hardness and the dilution rates of each build-up layers 3 in Example and Comparative Example. In Table 1, the hardness is shown as a ratio (hardness ratio) of the hardness of each portion of the build-up layer 3 in Example and Comparative Example, to the hardness of the build-up layer 3 in the vicinity of the weld end portion of Example. In addition, in Table 1, the dilution rate is shown as a ratio (dilution rate ratio) of the aforementioned dilution rate of the build-up layer 3 at the weld end portion of Example, to the dilution rate of the build-up layer 3 at the weld end portion of Comparative Example.

TABLE 1

| | | | | | Dilution rate |
|---|---|---|---|---|---|
| | | Hardness ratio | | | ratio (to |
| | | (to the end portion of Example) | | | Comp. Ex.) |
| | | Near | Near | Near | Near |
| | | end | middle | end | end |
| | Cooling | portion | portion | portion | portion |
| Example | Yes | 1.39 | 1.08 | 1.00 | 0.625 |
| Comp. | No | 1.22 | 0.88 | 0.82 | 1 |
| Example | | | | | |

As shown in Table 1, the dilution rate of the build-up layer 3 at the weld end portion of Comparative Example was 1, while the aforementioned ratio (dilution rate ratio) of the dilution rate of the build-up layer 3 at the weld end portion of Example was 0.625. Namely, the dilution rate of the build-up layer 3 of Example 1 was lower than the dilution rate of the build-up layer 3 of Comparative Example. Namely, the increase in dilution rate of the build-up layer 3 of Example was more prevented than that of Comparative Example. In addition, as shown in Table 1, the hardness of the build-up layer in the vicinity of the weld end portion of Example was 1, while the hardness (hardness ratio) of the build-up layer 3 in the vicinity of the weld start portion of Comparative Example, in the vicinity of the weld middle portion thereof and in the vicinity of the weld end portion thereof were 1.22, 0.88 and 0.82, respectively. On the other hand, the hardness of the build-up layer 3 in the vicinity of the weld end portion of Example was 1, while the hardness (hardness ratio) of the build-up layer 3 in the vicinity of the weld start portion of Example and in the vicinity of the weld middle portion thereof were 1.39 and 1.08, respectively. Namely, the hardness of each portion of the build-up layer 3 of Example was more improved than that of Comparative Example.

From the above results, it can be understood that cooling of the workpiece 2 during the build-up welding prevents the increase in dilution rate of the build-up layer 3, and improves the hardness of the build-up layer 3.

In the aforementioned embodiment and Example, the build-up layer 3 is formed in the build-up step by supplying the filler metal 35 to the surface to be built-up 2a along the longitudinal direction, and by applying the laser beam 45 thereto. However, the present invention is not limited thereto. The build-up layer 3 may be formed by applying the laser beam 45 to a filler metal layer formed by thermally spraying or applying the filler metal 35 to the surface to be built-up 2a. In this case, the welding equipment 10 may comprise, instead of the filler-metal supply unit 30, a filler-metal-layer forming unit that forms a filler metal layer by thermally spraying or applying the filler metal 35 to the surface to be built-up 2a. The supporter 20 may support the workpiece 2 with the filler metal layer formed thereon, and the laser irradiator 40 may apply a laser beam to the workpiece 2 with the filler metal layer formed thereon. In addition, in this case, the welding method may comprise a filler-metal-layer forming step of forming a filler metal layer by thermally spraying or applying the filler metal 35 to the surface to be built-up 2a. In the build-up step, the laser beam 45 may be applied to the filler metal layer after the filler-metal-layer forming step to melt again the filler metal 35 of the filler metal layer so as to form the build-up layer 3 on the surface to be built-up 2a.

As described above, the welding method according to the embodiment is a welding method for subjecting a surface to be built-up 2a of an elongated workpiece 2 to a build-up welding along a longitudinal direction of the workpiece 2, the welding method comprising a step for forming a build-up layer 3 on the surface to be built-up 2a by supplying a filler metal 35 to the surface to be built-up 2a along the longitudinal direction and by applying a laser beam 45 thereto to melt the filler metal 35. A refrigerant 85 is supplied to the workpiece 2, during the step for forming the build-up layer. Such a welding method can prevent the increase in temperature of each portion of the workpiece 2 caused by the heat applied by the laser beam 45. Thus, the increase in dilution rate of the build-up layer 3 is prevented and the decrease in hardness of the build-up layer 3 is prevented.

Alternatively, the welding method according to the embodiment is a welding method for subjecting a surface to be built-up 2a of an elongated workpiece 2 to a build-up welding process along a longitudinal direction of the workpiece 2, which welding method may comprise: a step for forming a filler metal layer by thermally spraying or applying a filler metal 35 to the surface to be built-up 2a; and after the filler-metal-layer is formed, a step for forming a build-up layer 3 on the surface to be built-up 2a by applying a laser beam 45 to the filler metal layer along the longitudinal direction to again melt the filler metal 35 of the filler metal layer. A refrigerant 85 may be supplied to the surface to be built-up of the workpiece, during the step for forming the build-up layer. Such a welding method can also prevent the increase in temperature of each portion of the workpiece 2 caused by the heat applied by the laser beam 45. Thus, the increase in dilution rate of the build-up layer 3 is prevented and the decrease in hardness of the build-up layer 3 is prevented.

In the welding method according to the embodiment, the refrigerant 85 is supplied to the workpiece 2 at a position forward an application position on the workpiece 2 to which the laser beam 45 is applied, in the relative movement direction D1 of the application position with respect to the workpiece 2. Thus, each portion of the workpiece 2 can be cooled before the filler metal 35 molten by the laser beam 45 lands on the portion, whereby the possibility of cracking of the build-up layer 3 can be reduced.

In the embodiment, the workpiece 2 may be hollow, and the refrigerant 85 may be supplied to a hollow area inside the workpiece 2. In this case, the possibility that the refrigerant 85 scatters or diffuses is prevented by the workpiece 2 itself.

In the embodiment, the refrigerant 85 is water. This prevents the possibility that the workpiece 2, the build-up layer 3 and the welding equipment 85 are eroded or so by the refrigerant 85.

In the embodiment, the workpiece 2 is rotated around the rotation axis 70X along the longitudinal direction, during the step for forming the build-up layer. Thus, the build-up layer 3 is formed spirally on the surface to be built-up 2a. Namely, the build-up layer 3 can be formed on the entire circumference of the surface to be built-up 2a.

In addition, the welding equipment 10 according to the embodiment is a welding equipment 10 for subjecting a surface to be built-up 2a of an elongated workpiece 2 to a build-up welding process along a longitudinal direction of the workpiece 2, the welding equipment 10 comprising a supporter 20, a filler-metal supply unit 30, a laser irradiator 40, a longitudinal motion drive 60, and a refrigerant supply unit 80. The supporter 20 supports the workpiece 2. The filler-metal supply unit 30 supplies a filler metal 35 to the surface to be built-up 2a of the workpiece 2. The laser irradiator 40 has a laser oscillator 41, and a laser emitter 43 that emits a laser beam 45 oscillated by the laser oscillator 41 toward the workpiece 2 supported by the supporter 20. The longitudinal motion drive 60 relatively moves the laser emitter 43 along the longitudinal direction with respect to the workpiece 2 supported by the supporter 20. The refrigerant supply unit 80 supplies a refrigerant 85 to the surface to be built-up 2a of the workpiece 2 supported by the supporter 20. Such a welding equipment 10 can prevent the increase in temperature of each portion of the workpiece 2 caused by the heat applied by the laser beam 45, by supplying the refrigerant 85 to the workpiece 2 while the laser beam 45 is being applied to the workpiece 2. Thus, the increase in dilution rate of the build-up layer 3 can be prevented and the decrease in hardness of the build-up layer 3 can be prevented.

Alternatively, the welding equipment 10 according to the embodiment is a welding equipment 10 for subjecting a surface to be built-up 2a of an elongated workpiece 2 to a build-up welding process along a longitudinal direction of the workpiece 2, which welding equipment 10 may comprise a filler-metal-layer forming unit, a supporter 20, a laser irradiator 40, a longitudinal motion drive 60, and a refrigerant supply unit 80. The filler-metal-layer forming unit may form a filler metal layer by thermally spraying or applying a filler metal 35 to the surface to be built-up 2a. The supporter 20 may support the workpiece 2 with the filler metal layer formed thereon. The laser irradiator 40 may have a laser oscillator 41, and a laser emitter 43 that emits a laser beam 45 oscillated by the laser oscillator 41 toward the workpiece 2 supported by the supporter 20. The longitudinal motion drive 60 may relatively move the laser emitter 43 along the longitudinal direction with respect to the workpiece 2 supported by the supporter 20. The refrigerant supply unit 80 may supply a refrigerant 85 to the surface to be built-up 2a of the workpiece 2 supported by the supporter 20. Such a welding equipment 10 can also prevent the increase in temperature of each portion of the workpiece 2 caused by the heat applied by the laser beam 45, by supplying the refrigerant 85 to the workpiece 2 while the laser beam 45 is being applied to the workpiece 2. Thus, the increase in dilution rate of the build-up layer 3 can be prevented and the decrease in hardness of the build-up layer 3 can be prevented.

In the embodiment, the refrigerant supply unit 80 has the nozzle 82 for ejecting the refrigerant 85. The longitudinal motion drive 60 relatively moves the nozzle 82, together with the laser emitter 43, along the longitudinal direction with respect to the workpiece 2 supported by the supporter 20. Such a welding equipment 10 can efficiently prevent the increase in temperature of the workpiece 2 caused by the heat applied by the laser beam 45 from the end to the start of the build-up welding process.

In the embodiment, the nozzle 82 is positioned forward the laser emitter 43 in the relative movement direction D1 of the laser emitter 43 with respect to the workpiece 2. Such a welding equipment 10 can cool each portion of the workpiece 2 before the filler metal 35 molten by the laser beam 45 lands on the portion, whereby the possibility of cracking of the build-up layer 3 can be reduced.

In the embodiment, the welding equipment 10 further comprises the rotational motion unit 70 that rotates the workpiece 2 supported by the supporter 20 around the rotation axis 70X along the longitudinal direction. Such a welding equipment 10 can form the build-up layer 3 spirally on the surface to be built-up 2a. Namely, the build-up layer 3 can be formed on the entire circumference of the surface to be built-up 2a.

According to an embodiment, a welding method and a welding equipment for subjecting a workpiece to a build-up welding process can be provided, which are capable of improving a hardness of a build-up layer.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fail within the scope and spirit of the invention. In addition, it goes without saying that these embodiments and modifications can be partially combined as appropriate, within the range of the scope of the present invention.

What is claimed is:

1. A welding method for subjecting a surface to be built-up of an elongated workpiece to a build-up welding process along a longitudinal direction of the workpiece, the welding method comprising:
a step for forming a build-up layer on the surface to be built-up by supplying a filler metal to the surface to be built-up along the longitudinal direction and by applying a laser beam thereto to melt the filler metal;
wherein a refrigerant is supplied to the surface to be built-up of the workpiece, during the step for forming the build-up layer.

2. The welding method according to claim 1, wherein
in the step for forming a build-up layer, the filler metal is supplied to the surface to be built-up while the laser beam is applied thereto.

3. The welding method according to claim 1, wherein
the refrigerant is supplied to the workpiece at a position forward an application position of the laser beam on the workpiece, in a relative movement direction of the application position with respect to the workpiece.

4. The welding method according to claim 1, wherein
the refrigerant is water.

5. The welding method according to claim 1, wherein
the workpiece is rotated around a rotation axis along the longitudinal direction, during the step for forming the build-up layer.

6. The welding method according to claim 1, wherein
in the step for forming a build-up layer, the filler metal is supplied to the surface to be built-up by forming a filler metal layer by thermally spraying or applying a filler metal to the surface to be built-up; and
after the filler metal layer is formed, a laser beam is applied to the filler metal layer along the longitudinal direction to again melt the filler metal of the filler metal layer.

7. The welding method according to claim 6, wherein
the refrigerant is supplied to the workpiece at a position forward an application position of the laser beam on the workpiece, in a relative movement direction of the application position with respect to the workpiece.

8. The welding method according to claim 6, wherein
the refrigerant is water.

9. The welding method according to claim 6, wherein
the workpiece is rotated around a rotation axis along the longitudinal direction, during the step for forming the build-up layer.

10. A welding equipment for subjecting a surface to be built-up of an elongated workpiece to a build-up welding process along a longitudinal direction of the workpiece, the welding equipment comprising:
a supporter that supports the workpiece;
a filler-metal supply unit that supplies a filler metal to the surface to be built-up of the workpiece;
a laser irradiator having a laser oscillator, and a laser emitter that emits a laser beam oscillated by the laser oscillator toward the workpiece supported by the supporter;
a longitudinal motion drive that relatively moves the laser emitter along the longitudinal direction with respect to the workpiece supported by the supporter; and
a refrigerant supply unit that supplies a refrigerant to the surface to be built-up of the workpiece supported by the supporter.

11. The welding equipment according to claim 10, wherein
the refrigerant supply unit has a nozzle for ejecting the refrigerant; and
the longitudinal motion drive relatively moves the nozzle, together with the laser emitter, along the longitudinal direction with respect to the workpiece supported by the supporter.

12. The welding equipment according to claim 11, wherein
the nozzle is positioned forward the laser emitter in a relative movement direction of the laser emitter with respect to the workpiece.

13. The welding equipment according to claim 10, further comprising a rotational motion unit that rotates the workpiece supported by the supporter around a rotation axis along the longitudinal direction.

14. A welding equipment for subjecting a surface to be built-up of an elongated workpiece to a build-up welding process along a longitudinal direction of the workpiece, the welding equipment comprising:
a filler-metal-layer forming unit that forms a filler metal layer by thermally spraying or applying a filler metal to the surface to be built-up;
a supporter that supports the workpiece with the filler metal layer formed thereon;
a laser irradiator having a laser oscillator, and a laser emitter that emits a laser beam oscillated by the laser oscillator toward the workpiece supported by the supporter;
a longitudinal motion drive that relatively moves the laser emitter along the longitudinal direction with respect to the workpiece supported by the supporter; and
a refrigerant supply unit that supplies a refrigerant to the surface to be built-up of the workpiece supported by the supporter.

15. The welding equipment according to claim 14, wherein
the refrigerant supply unit has a nozzle for ejecting the refrigerant; and
the longitudinal motion drive relatively moves the nozzle, together with the laser emitter, along the longitudinal direction with respect to the workpiece supported by the supporter.

16. The welding equipment according to claim 15, wherein
the nozzle is positioned forward the laser emitter in a relative movement direction of the laser emitter with respect to the workpiece.

17. The welding equipment according to claim 14, further comprising a rotational motion unit that rotates the workpiece supported by the supporter around a rotation axis along the longitudinal direction.
